(19) United States
(12) Patent Application Publication
(10) Pub. No.: US 2011/0097679 A1
(43) Pub. Date: Apr. 28, 2011

(54) DEVICE FOR PERFORMING CHEMICAL AND/OR PHYSICAL REACTIONS BETWEEN A SOLID MATERIAL AND A GAS

(76) Inventors: Verena Georg, Herdecke (DE); Detlev Kupper, Telgte (DE); Andreas Hoppe, Lippstadt (DE); Heinz-Werner Thiemeyer, Ennirgerloh (DE); Daniel Klegraf, Ruthen-Westereiden (DE); Thomas Deck, Ennigerloh (DE); Stefanie Richter, Detmold (DE); Luis Lagar Garcia, Oviedo (ES)

(21) Appl. No.: 12/997,105

(22) PCT Filed: Jun. 25, 2008
(86) PCT No.: PCT/EP2008/058108

§ 371 Date: Dec. 9, 2010

(51) Int. Cl. F27B 15/10

(52) U.S. Cl. 432/27; 432/67

(57) ABSTRACT

The device according to the invention for performing chemical and/or physical reactions between a solid material and a gas, in particular for preheating, cooling and/or calcining fine-grained materials substantially comprises at least one helical and/or spiral line, in which a gas/solid material suspension is separated by centrifugal forces into a solid material flow and a gas flow and at least one separation chamber which is connected to the end of the helical and/or spiral line and which is connected to a gas line in order to direct the gas flow away or which is formed by a portion of the gas line, a solid material line for directing the solid material flow away being connected to the separation chamber. The helical and/or spiral line opens into the separation chamber tangentially at an angle of at least 30° relative to the horizontal and the cross-section of the separation chamber in the region of the opening is from 0.5 to 1.5 times as large as the cross-section of the helical and/or spiral line.

The invention relates to a device for carrying out chemical and/or physical reactions between a solid material and a gas, in particular for preheating, cooling and/or calcining fine-grained materials, having a plurality of steps arranged one above the other.

In particular, systems comprising a parallel flow heat-exchanger and a cyclone separator are known in the cement and minerals industry for preheating, cooling and/or calcining fine-grained materials. Such devices usually have a plurality of steps arranged one above the other, the gas flow being directed through all the steps in an upward direction whilst the solid material is supplied to the individual steps in the opposite direction.

Such systems have the disadvantage that they require an enormous structural height and the degree of separation in the cyclone separator is not always satisfactory. For instance, there often occur in the cyclones uncontrolled flows which, for example, are caused at the cyclone inlet by the intake gas flow being superimposed with the turbulent flow produced in the cyclone or by the gas flow direction being reversed in the cone of the cyclone. It is further possible for the particles already separated at the cyclone edge to be reintroduced into the gas intake flow of the cyclone.

Another problem is that the centrifugal forces change if the construction forms are of different sizes, with the same intake speeds, and different separation conditions thereby result.

Therefore, there was proposed in U.S. Pat. No. 4,318,697 a multi-step preheater for cement raw material whose individual steps each comprise a rising line and an adjoining helical and/or spiral line. The helical and/or spiral line has a rectangular cross-section and is connected to a lateral face of a parallelepipedal separation chamber. The connection location extends over the entire lateral face of the parallelepipedal separation chamber. The lower portion of the separation chamber narrows in a funnel-like manner and serves to direct away the solid material whilst the gas is being directed upwards.

The problem addressed by the invention is to improve the device for carrying out chemical and/or physical reactions between a solid material and a gas, in particular for preheating, cooling and/or calcining fine-grained materials, with regard to the degree of separation in the separation chamber.

According to the invention, that problem is solved by the features of claim 1.

The device according to the invention for carrying out chemical and/or physical reactions between a solid material and a gas, in particular for preheating, cooling and/or calcining fine-grained materials substantially comprises at least one helical and/or spiral line, in which a gas/solid material suspension is separated by centrifugal forces into a solid material flow and a gas flow and at least one separation chamber which is connected to the end of the helical and/or spiral line and which is connected to a gas line in order to direct the gas flow away or which is formed by a portion of the gas line, a solid material line for directing the solid material flow away being connected to the separation chamber. The helical and/or spiral line opens into the separation chamber tangentially at an angle of at least 30° relative to the horizontal and the cross-section of the separation chamber in the region of the opening is from 0.5 to 1.5 times as large as the cross-section of the helical and/or spiral line.

Consequently, the helical and/or spiral line has a gradient relative to the horizontal of at least 30° at least in the region of the opening into the separation chamber.

According to the invention, a helical and/or spiral line is intended to refer to a line which is constructed so as to be helical and/or spiral at least in portions. The rotation of the helical and/or spiral line may also extend in particular only over a relatively small angular range of, for example, 90°.

Unlike the construction in accordance with U.S. Pat. No. 4,318,692, the helical and/or spiral line is not connected to a complete lateral face of the separation chamber but instead connected tangentially. The helical and/or spiral line of U.S. Pat. No. 4,318,692 further opens into the separation chamber by way of a horizontally orientated connection sleeve.

The connection of the helical and/or spiral line at an angle of at least 30° relative to the horizontal in conjunction with the tangential opening allows the solid material flow to continue to be directed downwards in a curve along the wall of the separation chamber. On the other hand, the gas flow is drawn off upwards in a type of twisting flow.

It has been found in tests forming the basis of the invention that it is further decisively significant that the cross-section of the separation chamber in the region of the opening is from 0.5 to 1.5 times as large as the cross-section of the helical and/or spiral line. If the cross-section of the helical and/or spiral line changes over its length, the significant aspect of the cross-sectional relationship is particularly the cross-section of the helical and/or spiral line in the region of the opening into the separation chamber.

In conventional separation cyclones, although the gas/solid material suspension line is also usually connected tangentially, it has a substantially smaller cross-section in comparison with the cross-section of the separation chamber and is further connected horizontally.

It has been found in the tests forming the basis of the invention that the device according to the invention allows an outstanding degree of separation with a comparatively small loss of pressure. There further also occurs no negative influence on the solid material/gas flow being introduced into the separation chamber and the solid material flow and gas flow to be directed out of the separation chamber.

The dependent claims relate to other constructions of the invention.

According to a preferred construction of the invention, the separation chamber is constructed so as to be round, in particular rotationally symmetrical.

Furthermore, the solid material line is connected in the lower region of the separation chamber and the gas line is connected in the upper region of the separation chamber. The lower portion of the separation chamber may further narrow in a funnel-like manner, the solid material line being connected to the separation chamber portion which narrows in a funnel-like manner.

The cross-section of the separation chamber in the region of the opening is preferably from 0.5 to 1.5 times as large as the cross-section of the gas line. According to a construction of the invention, the lower portion of the gas line forms the separation chamber. However, it is also conceivable for the gas line to extend into the separation chamber in the manner of a submerged pipe.

The device can particularly be used as a preheater or calcinator in cement production. In the case of a preheater, a multiple-step and/or multiple-strand arrangement having a plurality of separation chambers and associated helical and/or spiral lines is particularly advantageous.

Other advantages and constructions of the invention will be explained in greater detail below with reference to the description and drawings, in which:

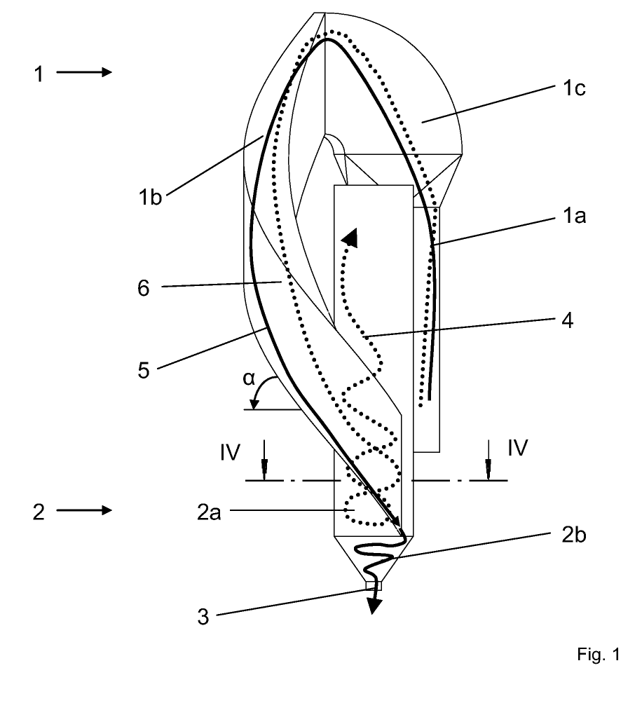

FIG. 1 is a side view of a device according to the invention,

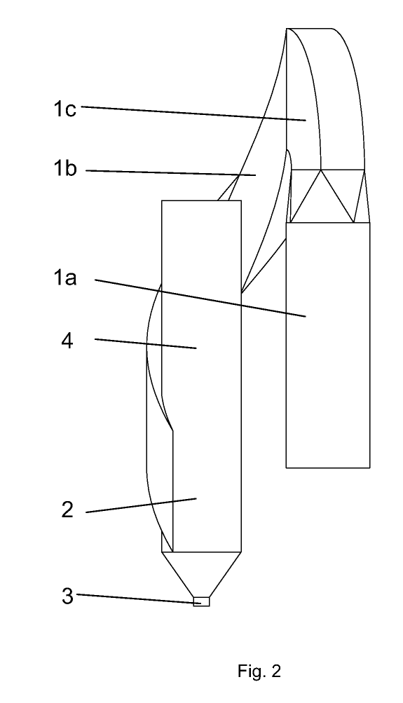

FIG. 2 is a side view according to FIG. 1 rotated through 90°,

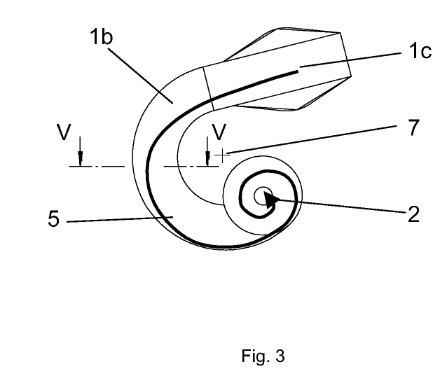

FIG. 3 is a top view of the step according to FIG. 1,

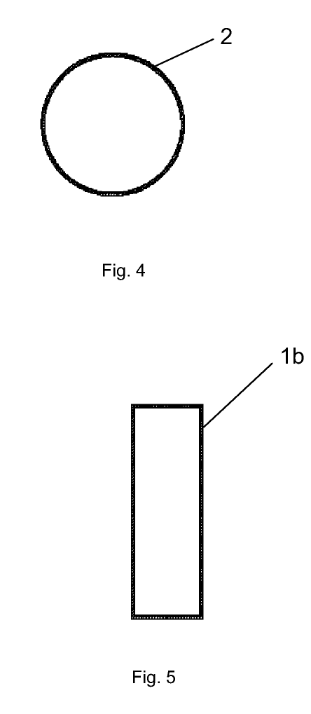

FIG. 4 is a section through the separation chamber along the line IV-IV of FIG. 1,

FIG. 5 is a section through the helical and/or spiral line along the line V-V of FIG. 3,

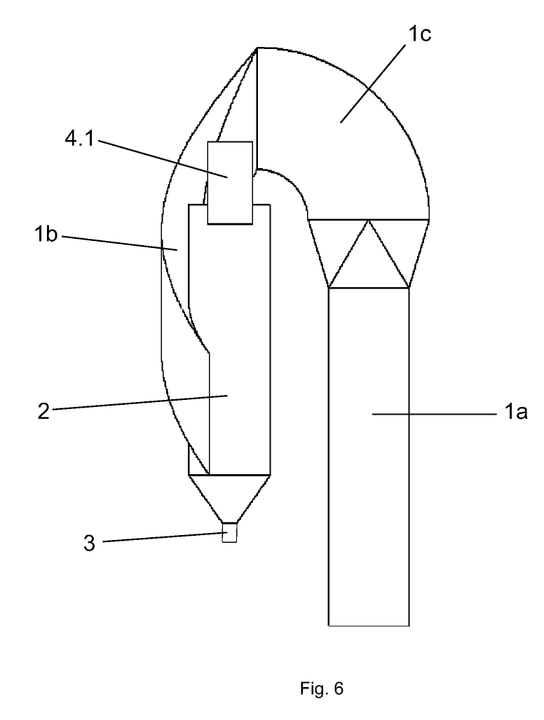

FIG. 6 is a side view of the device according to a second embodiment,

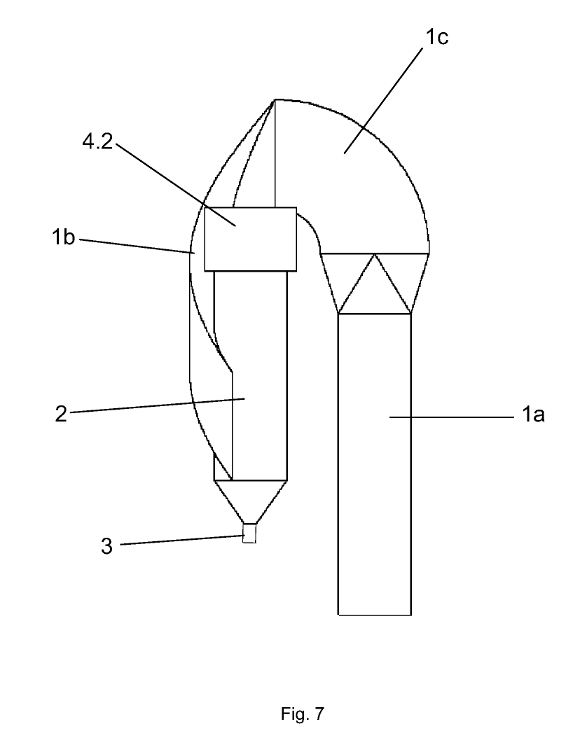

FIG. 7 is a side view of the device according to a third embodiment,

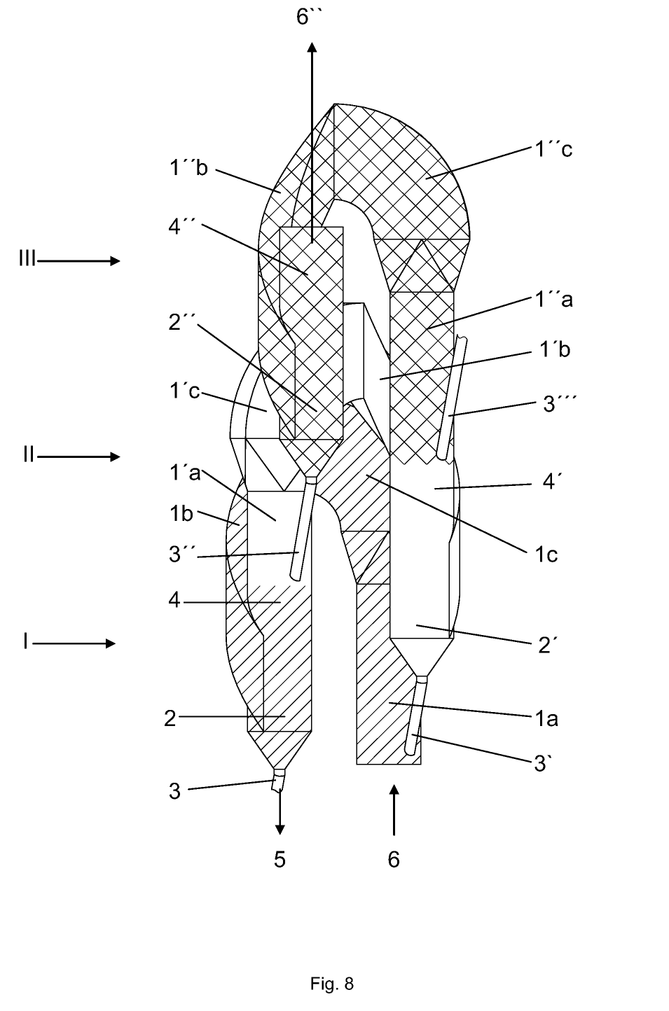

FIG. 8 is a side view of the device with three steps arranged one above the other,

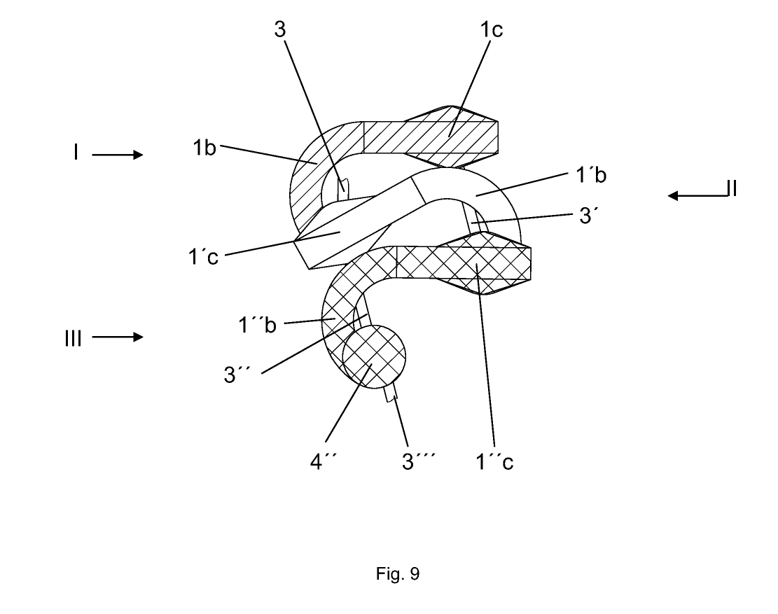

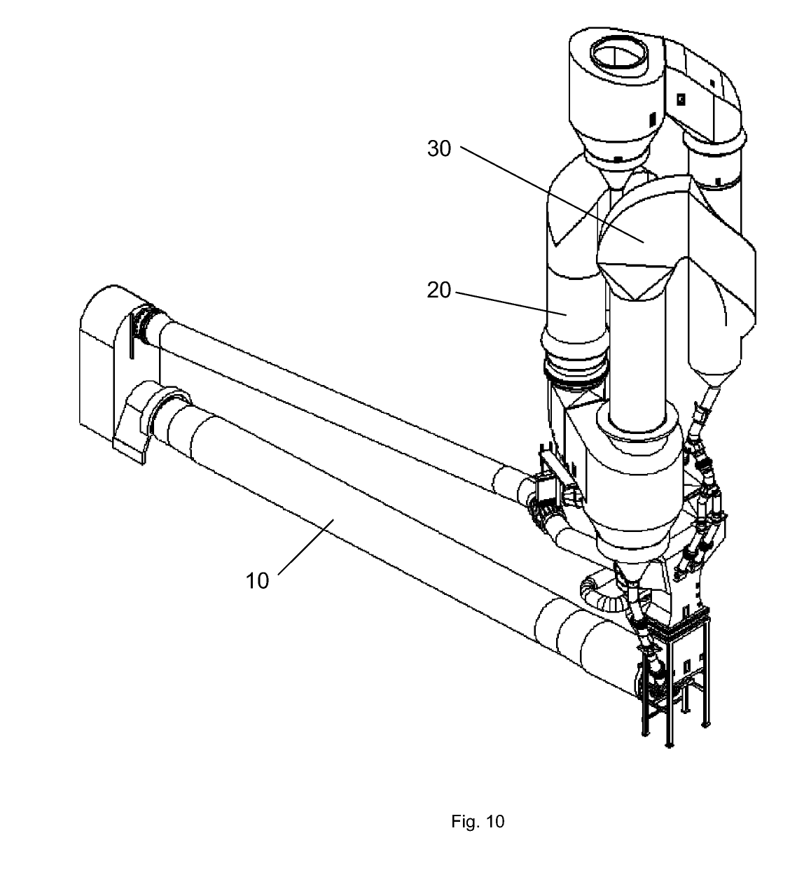

FIG. 9 is a top view of the device according to FIG. 8 and

FIG. 10 is a three-dimensional illustration of an arrangement for producing cement clinker.

FIGS. 1 to 5 illustrate a device for carrying out chemical and/or physical reactions between a solid material 5 and a gas 6. This may be, for example, a preheater or calcinator for thermally processing fine-grained material during cement production.

The device substantially comprises a gas/solid material suspension line 1, a separation chamber 2 for separating the supplied solid material from the supplied gas, a solid material line 3 for directing the separated solid material away and a gas line 4 for directing the separated gas away.

In order to carry out chemical and/or physical reactions between a solid material 5 and a gas, the gas/solid material suspension is supplied to the separation chamber 2 via the gas/solid material suspension line 1.

The gas/solid material suspension line 1 has an ascending line portion which is in the form of a rising line 1a and a descending line portion which is in the form of a helical and/or spiral line 1b. There is further provided a redirecting head 1c which connects the rising line 1a to the helical and/or spiral line 1b. When viewed in a vertical direction, at least the start of the helical and/or spiral line 1b is higher than its opening end at the separation chamber 2.

In the helical and/or spiral line 1b, the gas/solid material suspension is separated into a solid material flow and a gas flow owing to the centrifugal forces.

In the embodiment illustrated, the helical and/or spiral line lb opens into the separation chamber 2 tangentially relative to the horizontal at an angle a of at least 30°, preferably in a range from 30° to 60°. In the region of the opening, the separation chamber 2 is in the form of a cylindrical portion 2a, which a portion 2b which narrows in a funnel-like manner adjoins below.

The solid material line 3 is connected to the separation chamber portion 2b which narrows in a funnel-like manner whilst the cylindrical portion 2a merges into the gas line 4.

In the embodiment illustrated, the gas line 4 and the cylindrical portion 2a of the separation chamber have the same diameter. Therefore, it would also be possible to say that the separation chamber is formed by the lower portion of the gas line 4.

FIGS. 4 and 5 illustrate the cross-section of the separation chamber 2 in the plane of section IV-IV of FIG. 1 and the cross-section of the helical and/or spiral line 1b in the plane of section V-V of FIG. 3.

The clear cross-section of the separation chamber in the region of the opening of the helical and/or spiral line is intended to be from 0.5 to 1.5 times as large as the clear cross-section of the helical and/or spiral line.

Owing to those dimensions and the helical and/or spiral line 1b which is directed obliquely downwards and which is tangentially connected to the separation chamber 2, the solid material 5 is directed in a curve into the separation chamber portion 2b which narrows in a funnel-like manner and then reaches the solid material line 3 (see FIGS. 1 and 3).

The gas 6 is directed away with a twisting flow upwards into the gas line 4 along the inner wall of the cylindrical portion 2a of the separation chamber (see FIG. 1). The flow into the separation chamber 2 directed obliquely downwards also prevents the intake gas flow from becoming superimposed with the twisting flow produced in the separation chamber in the region of the opening of the helical and/or spiral line 1b.

As can be seen from FIG. 3, the helical and/or spiral line 1b extends over an angular range of approximately 180°. According to the invention, however, the angular range may also be selected so as to be larger or smaller. It is further conceivable for the radius and/or the gradient and/or the cross-section shape and/or the cross-section size of the helical and/or spiral line 1b to change in the direction of flow of the gas/solid material suspension.

FIG. 6 shows an embodiment, in which the gas line 4.1 has a smaller diameter than the separation chamber 2 and projects into the separation chamber 2 in the manner of a submerged pipe.

In the embodiment according to FIG. 7, the gas line 4.2 has a larger diameter than the separation chamber 2. In the tests forming the basis of the invention, however, it was found to be advantageous for the cross-section of the separation chamber 2 in the region of the opening to be from 0.5 to 1.5 times as large as the cross-section of the gas line.

However, the gas line may have at least a first and a second cross-section size and/or shape in the direction of flow of the gas.

The axis of the helical and/or spiral line 1b is preferably vertical. However, it would also be conceivable for the axis, about which the helical and/or spiral line 1b is wound, to be inclined relative to the vertical.

With reference to FIGS. 8 and 9, there is described below a device which has three steps I, II, III and which is, for example, a three-step preheater for cement raw material. Each individual step may be constructed in accordance with FIGS. 1 to 7.

In such a multiple-step arrangement, a solid material to be processed is supplied at the top step III via a solid material line 3″′ and is directed away in the form of processed solid material 5 from the bottom step I. The solid material line opens in the region of the rising lines of the individual steps whilst the gas line of a step merges into the rising line of the next step up.

Consequently, whilst the solid material is directed through the three steps in a downward direction, the gas flows through the arrangement in the opposite direction. The gas 6 which is intended to be supplied to the bottom step is, for example, the hot exhaust gas of an oven or a calcinator. The gas 6″ directed away via the gas line 4″ in the third step is supplied, for example, for dust removal, to a filter or a highly efficient separator connected downstream. The processed solid material 5 reaches, for example, a calcinator or an oven for further processing.

Owing to the construction of the gas/solid material suspension line 1 with a rising line 1a and a descending helical or spiral line 1b, the three steps can be arranged so as to be very compact and entwined round each other. There is further provision for the helical or spiral lines 1b, 1′b, 1″b of at least two successive steps to be constructed alternately so as to be orientated clockwise and anti-clockwise (see FIG. 9).

According to the invention, it is conceivable for the radius and/or the gradient and/or the cross-section shape and/or the cross-section size of the helical and/or spiral line 1b to change in the direction of flow of the gas/solid material suspension. In that manner, on the one hand, it is possible to influence the pre-separation of the gas/solid material suspension in the region of the helical and/or spiral line and, on the other hand, it is possible for the helical and/or spiral line 1b to be adapted to external circumstances. This is particularly advantageous when a plurality of steps are nested one in the other and arranged one above the other.

The radius, gradient, cross-section shape and/or cross-section size may also change abruptly in the direction of flow and/or continuously at least in a portion. For instance, a radius reduction brings about an increase in the centrifugal force, for example, whilst an increase in radius corresponds to a reduction in the centrifugal force. It is possible to influence the flow rate by changing the cross-section shape and size.

Finally, FIG. 10 is a three-dimensional illustration of an arrangement for thermally processing fine-grained material during cement production, having a cylindrical rotary kiln 10, a calcinator 20 and a preheater 30. The calcinator 20 and/or the preheater 30 may be constructed in accordance with the device described in FIGS. 1 to 9.

1. Device for carrying out chemical and/or physical reactions between a solid material and a gas, in particular for preheating, cooling and/or calcining fine-grained materials, having:
at least one helical and/or spiral line (1b), in which a gas/solid material suspension is separated by centrifugal forces into a solid material flow (5) and a gas flow (6) and
at least one separation chamber (2) which is connected to the end of the helical and/or spiral line and which is connected to a gas line (4; 4.1; 4.2) in order to direct the gas flow away or which is formed by a portion of the gas line, a solid material line for directing the solid material flow away being connected to the separation chamber,
characterised in that the helical and/or spiral line (1b) opens into the separation chamber (2) tangentially at an angle (α) of at least 30° relative to the horizontal and the cross-section of the separation chamber in the region of the opening is from 0.5 to 1.5 times as large as the cross-section of the helical and/or spiral line.

2. Device according to claim 1, characterised in that the separation chamber (2) is constructed so as to be round.

3. Device according to claim 1, characterised in that the cross-section of the separation chamber (2) in the region of the opening is from 0.5 to 1.5 times as large as the cross-section of the gas line (4; 4.1; 4.2).

4. Device according to claim 1, characterised in that the solid material line (3) is connected in the lower region of the separation chamber (2) and the gas line (4) is connected in the upper region of the separation chamber.

5. Device according to claim 1, characterised in that the lower portion of the separation chamber (2) is constructed so as to narrow in a funnel-like manner.

6. Device according to claim 5, characterised in that the solid material line (3) is connected to the portion (2b) of the separation chamber (2) narrowing in a funnel-like manner.

7. Device according to claim 1, characterised in that the gas line (4.1) extends into the separation chamber in the manner of a submerged pipe.

8. Device according to claim 1, characterised in that the gas line (4) has at least a first and a second cross-section size and/or shape in the direction of flow of the gas.

9. Device according to claim 1, characterised in that the axis, about which the helical and/or spiral line (1b) is wound, is inclined relative to the vertical.

10. Device according to claim 1, characterised in that the device is in the form of a multiple-step and/or multiple-strand arrangement having a plurality of separation chambers (2, 2′, 2″) and associated helical and/or spiral lines (1b, 1′b, 1″b).

11. Device according to claim 1, characterised in that the separation chamber (2) is constructed so as to be rotationally symmetrical.

12. Device according to claim 1, characterised in that the separation chamber (2) and the gas line (4.1; 4.2) have different diameters.

13. Method for carrying out chemical and/or physical reactions between a solid material and a gas, in particular for preheating, cooling and/or calcining fine-grained materials, having a device according to one or more of the preceding claims, wherein the gas/solid material suspension is introduced into the separation chamber (2) via the helical and/or spiral line (1b) in such a manner that the gas flow produces a twisting flow in the separation chamber (2).
